(19) United States
(12) Patent Application Publication
(10) Pub. No.: US 2011/0027536 A1
(43) Pub. Date: Feb. 3, 2011

(54) ROOFING UNDERLAYMENT

(75) Inventors: Thomas H. Malpass, Ottawa, IL (US); Scott W. Wollack, Peru, IL (US)

Correspondence Address: BARNES & THORNBURG LLP, P.O. Box 2786, CHICAGO, IL, 60690-2786, US

(73) Assignee: TEE GROUP FILMS, INC., Ladd, IL (US)

(21) Appl. No.: 12/866,647

(22) PCT Filed: Feb. 18, 2009
(86) PCT No.: PCT/US09/34393

§ 371 Date: Aug. 6, 2010

Related U.S. Application Data
(60) Provisional application No. 61/029,794, filed on Feb. 19, 2008.

(51) Int. Cl. B32B 3/00; B29C 59/04

(52) U.S. Cl. 428/172; 264/293

(57) ABSTRACT

A roofing underlayment that includes at least two layers that form a weather resistant barrier between the plywood sheeting and the top roofing layer. The roofing underlayment is fastened to the plywood sheeting and is covered with a roofing material such as shingles. The roofing underlayment is synthetic and includes a polymer is that is extruded or laminated to a woven or non-woven substrate. The use of an extruded polymer provides water proofing, strength, and energy efficiency. The roofing underlayment is embossed by use of an embossment process to allow for trapped water vapor escape and to enhance traction of the roofing surface.

This application claims priority to U.S. Provisional Application Ser. No. 61/029,794 that was filed on Feb. 19, 2008 and is incorporated by reference herein.

### BACKGROUND

The present disclosure relates to underlayments, and in particular, to roofing underlayments for use under shingles. More particularly, the present disclosure relates to multi-layer roofing underlayments. For many decades organic felt has been used as the underlayment in roof installations. Roof joists are typically covered in plywood sheeting, which, in turn, is covered with the organic felt. The underlayment provides for a secondary defense against the elements. The organic felt material is not durable, which can be the cause of leaks and wood rot in a roofing structure.

### SUMMARY

A roofing underlayment in accordance with the present disclosure is a polymer material that is used to cover the plywood sheeting of a roof surface. The roofing underlayment includes at least two layers that form a weather resistant barrier between the sheeting and the top roofing layer. The roofing underlayment is fastened to the sheeting and covered with a roofing material such as shingles.

In illustrative embodiments, the roofing underlayment is synthetic and includes a polymer is that is extruded or laminated to a woven or non-woven substrate. The use of an extruded polymer provides water proofing, strength, and energy efficiency. The polymer material used for the extrusion can be both mono-layered or multi layered. Multi layered film can be used to provide multiple properties that otherwise may not be available in a mono-layered polymer. The polymer film layer may be formed to include either a smooth and embossed textured surface. The embossed texture allows for increased traction for roofers in wet conditions and allows water to run off the roof in the channels created by the embossment.

Additional features of the disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a side plan view of a process for forming an embossed film for use with the roofing underlayment;

FIG. 2 is a side plan view of the process of FIG. 1 adding a substrate backing that a molten film is extruded onto and showing the combination passing through an embossing roller and a backer roller;

FIG. 3 is a side plan view of the roofing underlayment showing an embossed polymer material having ridges and open spaces to allow gases to escape;

FIG. 4 is a side plan view of the roofing underlayment showing an embossed polymer film layer having a series of ridges and a substrate polymer backing that is extruded with the film layer;

FIG. 5 is a top view of the roofing underlayment showing an embossed pattern having triangular shaped areas that are raised in relief;

FIG. 6 is a side plan view of the roofing underlayment showing a polymer film having ridges and open spaces and an adhesive layer;

FIG. 7 is a enlarged side plan view of the roofing underlayment showing an embossment;

FIG. 8 is a perspective view of a roof showing the roofing underlayment attached to plywood sheeting beneath shingles;

FIG. 9 is a perspective view of the roofing underlayment showing water passing through the channels formed by the embossment;

FIG. 10 is a top view of the roofing underlayment showing another embossed pattern having diamond shaped areas that are raised in relief;

FIG. 11 is a top view of the roofing underlayment showing another embossed pattern having triangular shaped areas that are raised in relief;

FIG. 12 is a top view of the roofing underlayment showing another embossed pattern having square shaped areas that are raised in relief; and

FIG. 13 is a top view of the roofing underlayment showing another embossed pattern having hexagonal shaped areas that are raised in relief.

### DETAILED DESCRIPTION

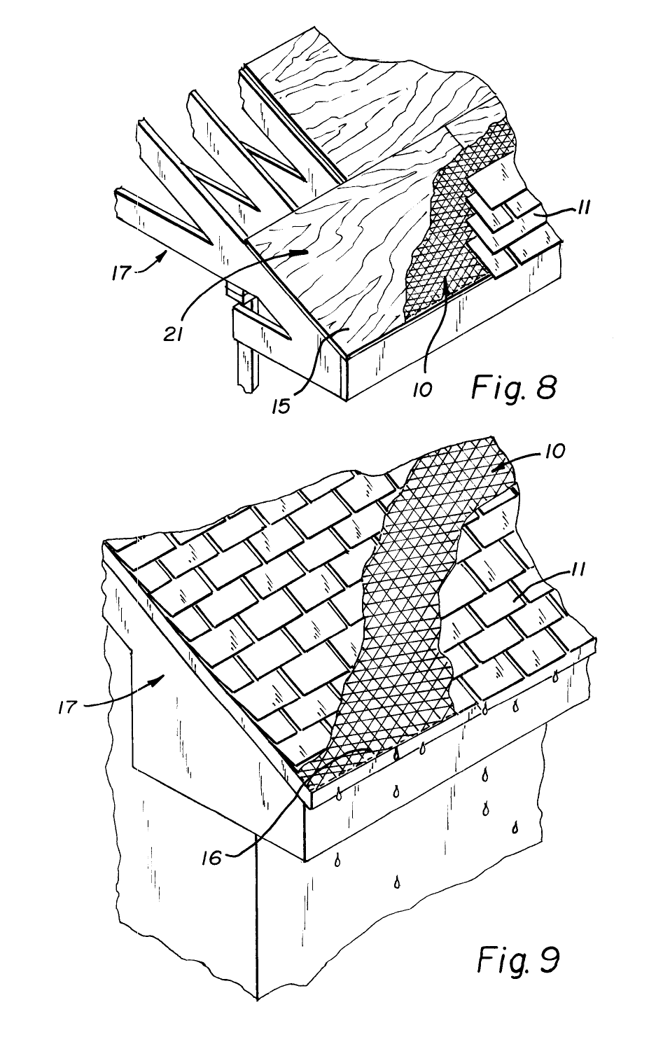

In an illustrative embodiment, a roofing underlayment 10 includes a polymer film layer 12 that is extruded or laminated onto a polyester based spun bond substrate 14, as shown in FIG. 5, using the process shown in FIG. 2. The roofing underlayment 10 is adapted to be installed onto the plywood sheeting 15 of a roof 17 beneath the asphalt shingles 11, as shown in FIG. 8. Roofing underlayment 10 is configured to permit condensation to pass through channels 16 formed in the roofing underlayment 10 as an embossment, as shown in FIG. 9. The polymer film layer 12 is preferably made from polyethylene or polypropylene.

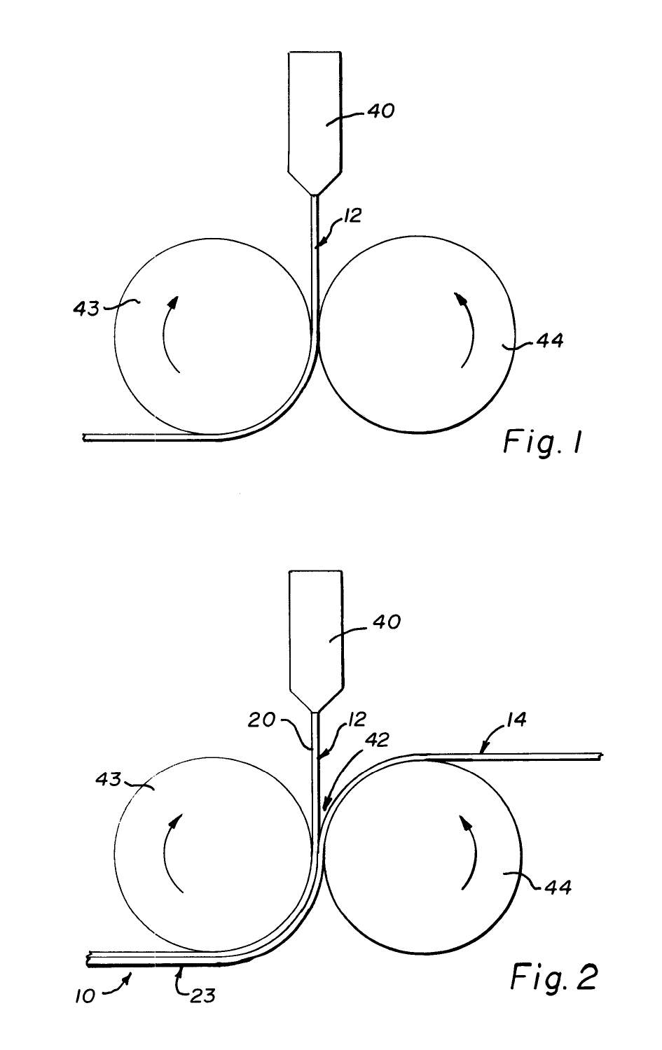

The embossed pattern 18, which is created during the process shown in FIGS. 1 and 2, increases the coefficient of friction of roofing underlayment 10 to increase surface traction when applied to a roofing surface 21, such as plywood 15 or wood planking. The higher coefficient of friction is designed to prevent roofers from loosing their footing when walking across a pitched roof.

Embossed pattern 18 can be added to the surface 20 of polymer film layer 12 to create relief. The embossing, formed by the process shown in FIG. 2, creates a controlled geometry in the material. The embossed relief can be added either to the polymer film layer 12 alone or to a film/substrate composite 23.

One of the possible embossing designs or patterns used to create the desired relief in polymer film layer 12 is shown in FIG. 5. The emboss relief creates raised regions 22 that significantly increase the coefficient of friction in polymer film layer 12. The higher the coefficient of friction of the roofing underlayment 10 the more slip resistant the material becomes, which makes it safer to walk on a roof having various pitches in a variety of weather conditions.

The embossed pattern 18 shown in FIG. 5 includes triangular raised regions 22 having edges 24 that form channels 16. Channels 16 permit moisture that has collected between the shingles 11 and the roofing underlayment 10 to gather and flow through channels 16 to prevent moisture from becoming trapped. Use of triangular raised regions 22 creates a first set of parallel channels 28, a second set of parallel channels 30, and a third set of parallel channels 32. The intersection of the channels 28, 30, and 32 forms a series of acute angles. The benefit of the overlapping channel design is that condensation can flow through alternate pathways in the event that a roofing nail 33 is blocking a first pathway in the polymer film layer 12.

The pattern, size, and depth of the embossing formed in the polymer film layer allows moisture to easily run off of the film surface through the embossing channels 28, 30, and 32. The embossing also contributes greatly to improving slip resistance of the polymer film material. When the polymer film layer 12 is embossed, the polymer material is stretched creating areas on the film that have a wall thickness that is thinner than other areas, as shown, for example, in FIG. 7. The embossment includes thin wall sections 34 and, thick wall sections 36.

Thin wall sections 34 are formed by stretching polymer film layer 12 during the embossing process of FIG. 2. As the polymer film layer 12 becomes thinner, it allows for greater air permeability 37 through the polymer material. The areas of the polymer film which have been embossed and stretched, allow for an increase in air permeability allowing the roofing underlayment 10 to be more breathable. Having a permeable polymer film layer 12 permits moisture, trapped between the roofing underlayment 10 and the plywood sheeting, to pass through the polymer film layer 12.

The process used to manufacture of the roofing underlayment 10 is shown in FIGS. 1 and 2. First, the spunbond polyester substrate is unwound into the machine. Next, a polymer material is extruded through a heated die 40 to form a polymer film 12. The polymer film 12 is next bonded to the spunbond polyester substrate 14 at the nip point 42. The polymer film 12 and spunbond polyester substrate 14 next pass through an engraved metal roller 43 and a backer roller 44. The engraved metal roller 43 is temperature controlled to cool the polymer film extrusion. Using this process, the pattern is cast into the film while being applied to a substrate backing. The embossed relief in the polymer film 12 can be created by pressing a relief pattern into a flat film and/or a flat film being applied to a backing substrate at the nip point.

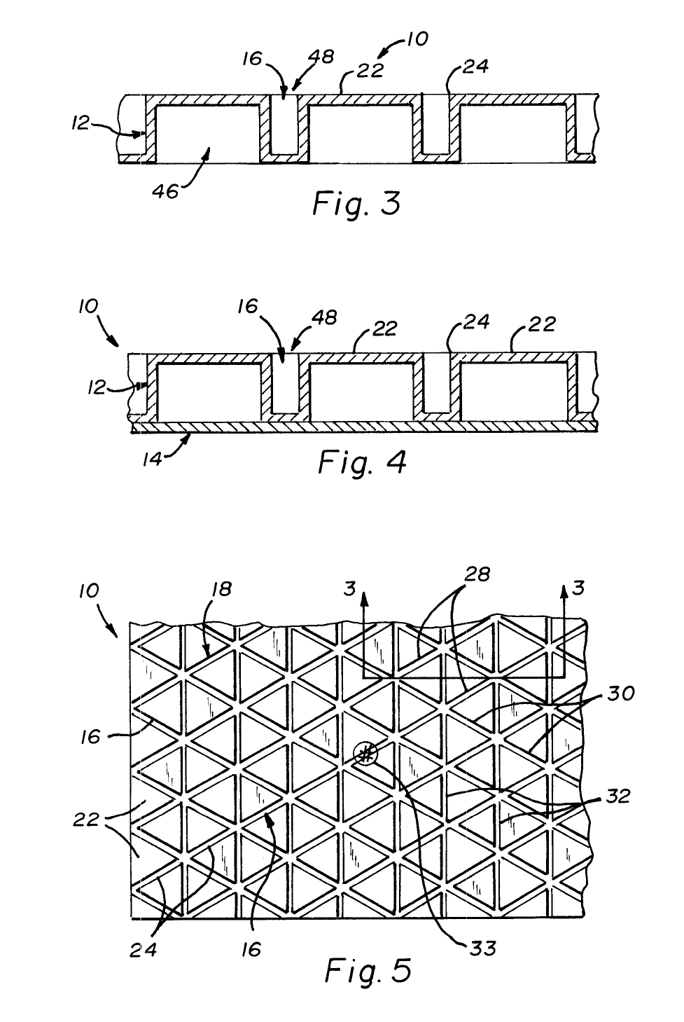

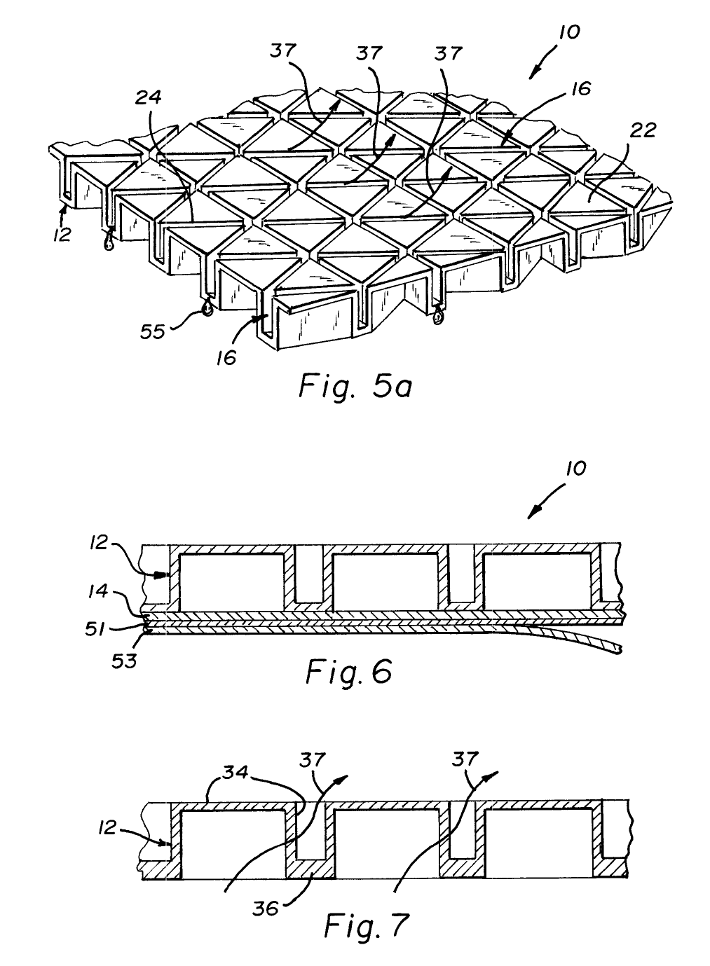

One method of manufacturing the roofing substrate 10 is to cast an embossed pattern into the molten polymer film as shown, for example, in FIG. 1. In this example, the embossed pattern is cast into the polymer film 12 alone. Using this method, the spunbond polyester substrate 14 is applied to the polymer film 12 using a binder material, such as an adhesive, in a later process step as shown in FIG. 4. One or more polymer layers can be co-extruded prior to embossing of the polymer material or the addition of the polyester spun bond substrate 14. FIG. 3 illustrates a magnified cross-sectional view of one embossed pattern applied to the polymer material. In this embodiment, the film 12 has a first set of wide channels 46 and a second set of narrow channels 48. The narrow channels 44 on the top side of the polymer film 12 form open spaces to allow gases to escape.

FIG. 4 shows a magnified cross-sectional view of another embossed pattern applied to the polymer film 12. Using the manufacturing methods, no open spaces occur on the underside of the polymer film 12, making the raised relief a solid structure. In this embodiment, channels 48 are formed on the upper side of the polymer film 12 only and the bottom side is relatively planar.

FIG. 5 illustrates another embodiment of roofing underlayment 10 having multiple layers coupled to polymer layer 12 including spunbond layer 14, tie layer 51 and membrane 53.

FIG. 5a is a perspective view of the roofing underlayment 10 showing triangular raised regions 22 and channels 16. The channels 16 adapted to permit water 55 to flow through the channels 16 to permit drainage. Embossing of polymer material 12 creates thin wall portions to allow water vapor 37 to permeate through polymer layer 12. Use of multiple channels permits the flow of water even when there is an obstruction blocking certain flow paths.

The roofing underlayment 10 uses of a polyester spunbond substrate 14 coated with a polymer film 12 that can either be smooth or embossed. The embossed pattern increases the coefficient of friction of the material by creating raised areas in relief, which, in turn, increase slip resistance and traction. The emboss pattern creates channels to allow moistures to easily run off a roof to which the roofing underlayment is applied. The embossed pattern also creates pockets for gases from an applied adhesive to escape. The embossed pattern also creates areas with a thinner polymer thickness which increases air permeability of the polymer material 12.

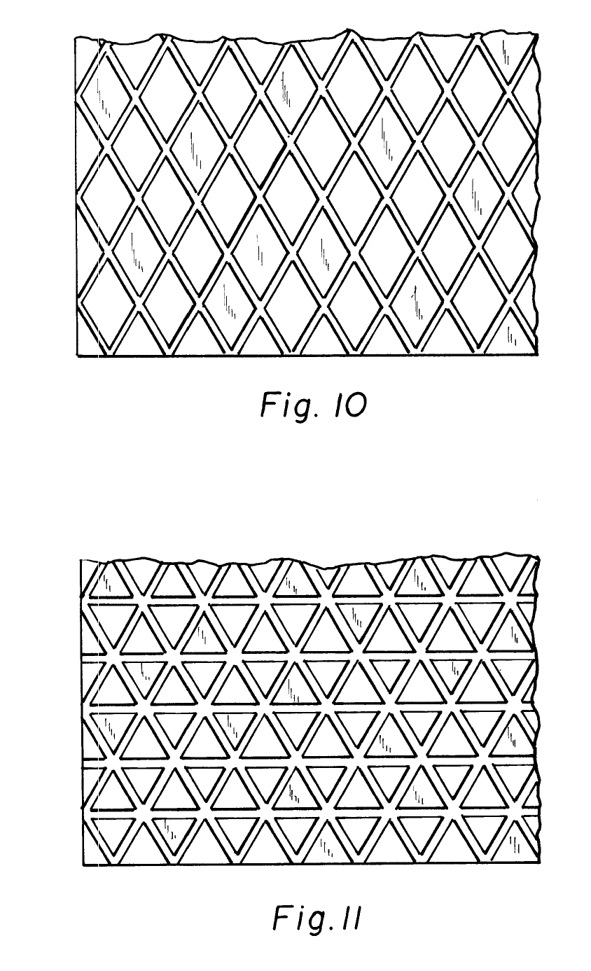

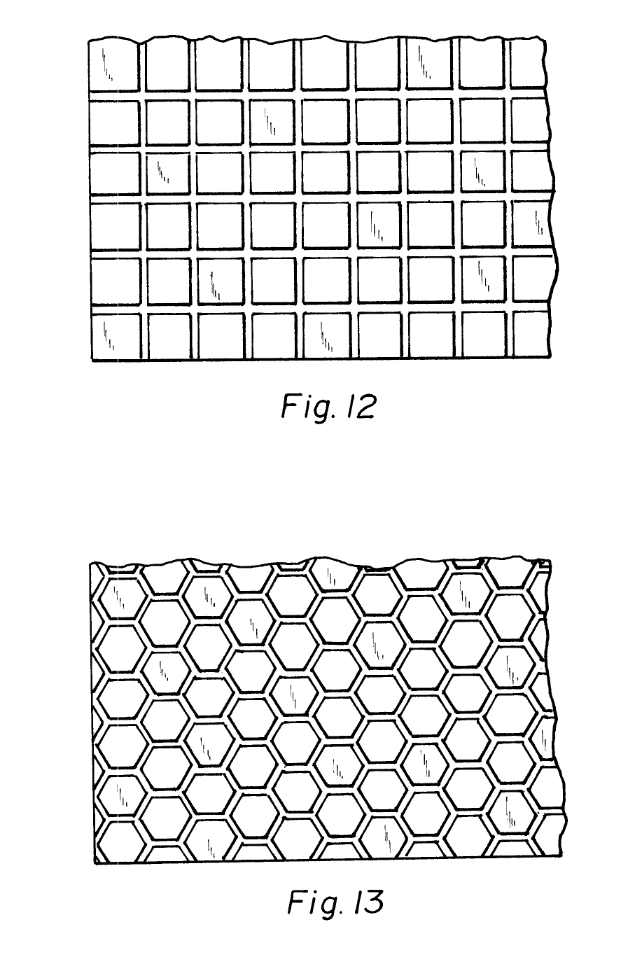

FIGS. 10-13 show alternate embossed patterns that can be applied to the polymer material 12. FIG. 10 illustrates the use of a diamond shaped areas raised in relief. FIG. 11 illustrates triangular areas that are raised in relief. FIG. 12 illustrates the use of square areas of relief and FIG. 13 illustrates the use of hexagonal raised areas of relief. These alternate embossed patterns enhance the traction of the roofing underlayment 10 and create channels for vapor permeation and for drainage runoff.

In use, the roofing underlayment 10 is manufactured using the techniques of FIGS. 1 and 2 and is stored on rolls. To use the roofing underlayment 10, a roofer unrolls and covers the plywood sheeting 21 with the roofing underlayment 10 with the polymer layer 12 facing upwardly and the spunbond polyester substrate 14 contacting the plywood sheeting 21. The roofing underlayment 10 is next stapled or nailed to the plywood sheeting. Once the roofing underlayment 10 is secured to the roof, the roofer will appreciate the enhanced traction created by the embossments in the material.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A roofing underlayment for use on a roof structure comprising
a non-woven fibrous layer;
a polymer layer that is extruded onto the fibrous layer;
wherein the fibrous layer and polymer layer are embossed to form an embossed pattern; and
wherein the fibrous layer and polymer layer form a waterproof barrier to protect the roof structure.

2. The roofing underlayment of claim 1, wherein the embossed pattern forms channels that permit moisture to run off of the polymer layer when the roofing underlayment is positioned on a roof structure.

3. The roofing underlayment of claim 2, wherein the embossed pattern includes ridges that form channels on the underside of the roofing underlayment to permit gases to escape to prevent pockets of gas from becoming trapped when the roofing underlayment is installed on a roof structure.

4. The roofing underlayment of claim 3 wherein embossed pattern creates areas in the polymer material with thinner wall thicknesses to increase air permeability of the polymer material to allow gas to escape from beneath the roofing underlayment.

5. The roofing underlayment of claim 2, wherein the embossed pattern increases the coefficient of friction at the surface of the polymer layer by forming raised areas in relief, to increase slip resistance and traction.

6. The roofing underlayment of claim 4, wherein the embossed pattern forms a triangular pattern across the polymer layer.

7. The roofing underlayment of claim 1, wherein the embossed pattern forms a series of triangular raised regions to form a first set of parallel channels.

8. The roofing underlayment of claim 7, wherein the embossed pattern forms a second set of parallel channels that are not parallel to the first set of parallel channels.

9. The roofing underlayment of claim 8, wherein the embossed pattern forms a third set of parallel channels that are not parallel to the first and second set of parallel channels.

10. The roofing underlayment of claim 9, wherein the intersection of the channels forms a series of acute angles between the channels to allow condensation to flow through alternate channels in the event that a roofing nail is blocking one or more channels in the roofing underlayment.

11. A roofing underlayment for use on a roof structure comprising
a non-woven fibrous layer having a first side and a second side;
a polymer layer coupled to a first side of the fibrous layer;
wherein the fibrous layer and polymer layer are embossed to form an embossed pattern having a series of channels to permit trapped moisture to escape; and
wherein the fibrous layer and polymer layer form a waterproof barrier to protect the roof structure.

12. The roofing underlayment of claim 11, wherein the embossed pattern forms a series of triangular raised regions to form a first set of parallel channels.

13. The roofing underlayment of claim 12, wherein the embossed pattern forms a second set of parallel channels that are not parallel to the first set of parallel channels.

14. The roofing underlayment of claim 13, wherein the embossed pattern forms a third set of parallel channels that are not parallel to the first and second set of parallel channels.

15. The roofing underlayment of claim 14, wherein the intersection of the channels forms a series of acute angles between the channels to allow condensation to flow through alternate channels in the event that a roofing nail is blocking one or more channels in the roofing underlayment.

16. The roofing underlayment of claim 11, wherein the polymer layer is attached to the fibrous layer by extrusion.

17. The roofing underlayment of claim 11, wherein the polymer layer is attached to the fibrous layer by lamination.

18. The roofing underlayment of claim 16 wherein embossed pattern creates areas in the polymer material with thinner wall thicknesses to increase air permeability of the polymer material to allow gas to escape from beneath the roofing underlayment.

19. A process for forming a roofing underlayment comprising the steps of:
forming a polymer film layer;
extruding the polymer film layer onto a non-woven fibrous layer;
passing the polymer film layer and the non-woven fibrous layer between an engraved roller and a backer roller to form an embossed pattern on the layers.

20. The process of claim 19 wherein embossed pattern creates areas in the polymer material with thinner wall thicknesses to increase air permeability of the polymer material to allow gas to escape from beneath the roofing underlayment.

21. The roofing underlayment of claim 19, wherein the embossed pattern forms a series of triangular raised regions to form a first set of parallel channels.

22. The roofing underlayment of claim 21, wherein the embossed pattern forms a second set of parallel channels that are not parallel to the first set of parallel channels.

23. The roofing underlayment of claim 22, wherein the embossed pattern forms a third set of parallel channels that are not parallel to the first and second set of parallel channels.

24. The roofing underlayment of claim 23, wherein the intersection of the channels forms a series of acute angles between the channels to allow condensation to flow through alternate channels in the event that a roofing nail is blocking one or more channels in the roofing underlayment.

25. A process for forming a roofing underlayment comprising the steps of:
forming a polymer film layer;
passing the polymer film layer between an engraved roller and a backer roller to form an embossed pattern in the polymer film layer;
attaching a non-woven fibrous layer to the embossed polymer film.
